(19) United States
(12) Patent Application Publication
(10) Pub. No.: US 2011/0307123 A1
(43) Pub. Date: Dec. 15, 2011

(54) ELECTRIC POWER LINE COMMUNICATION SYSTEM FOR VEHICLE

(75) Inventors: Taiji Abe, Nishio-city (JP); Yuji Sugimoto, Kariya-city (JP); Akira Takahashi, Nisshin-city (JP)

(73) Assignees: NIPPON SOKEN, INC., Nishio-city (JP); DENSO CORPORATION, Kariya-city (JP)

(21) Appl. No.: 13/156,436

(22) Filed: Jun. 9, 2011

(30) Foreign Application Priority Data
Jun. 11, 2010 (JP) 2010-133864

(51) Int. Cl. G06F 7/00

(52) U.S. Cl. 701/2; 701/1

(57) ABSTRACT

An in-vehicle electric power line communication system includes: a pair of direct current electric power lines functioning as electrically equilibrated communication lines; multiple communication devices communicating with each other via the communication lines; and an ignition switch. Each communication device applies a high frequency signal to the communication lines so that equilibrium communication is performed. One communication line starts and stops supplying direct current electricity according to a status of the ignition switch. Each communication device detects an electric potential of the one communication line or a potential difference between the direct current electric power lines. Each communication device determines the operation status of the vehicle based on the electric potential or the potential difference. Each communication device performs the equilibrium communication according to the operation status of the vehicle.

### CROSS REFERENCE TO RELATED APPLICATION

This application is based on Japanese Patent Application No. 2010-133864 filed on Jun. 11, 2011, the disclosure of which is incorporated herein by reference.

### TECHNICAL FIELD

The present invention relates to an electric power line communication system for a vehicle, in which multiple communication devices communicate with each other via an electric power line.

### BACKGROUND

In a vehicle, an electric power line communication system (Power Line Communication system, i.e., PLC system) for a vehicle is studied. In the system, multiple devices such as an ECU (i.e., electronic control unit) located on various positions of the vehicle communicate with each other via an electric power line, which is connected to an in-vehicle battery. Specifically, a high frequency signal is overlapped on a normal electric power supply in the electric power line. JP-A-2008-244701 corresponding to US 2010/0111201 discloses the electric power line communication system.

However, in the system, it may be considered that each communication device determines a vehicle condition such as a condition whether an engine of the vehicle runs, and then, based on the determination, the device decides an operation. A communication line in JP-A-2008-244701 is an electric power line, which is connected to a positive terminal and a negative terminal of the battery. Accordingly, when a construction for determining the vehicle condition is prepared, for example, the system includes a circuit for detecting a status of a key switch and for transmitting a detection result and a circuit for receiving a detection result signal from each communication device and for decoding the signal. Thus, the system has a complicated construction.

### SUMMARY

In view of the above-described problem, it is an object of the present disclosure to provide an electric power line communication system for a vehicle, in which each communication device determines a vehicle condition. The system has a simple construction.

According to an aspect of the present disclosure, an in-vehicle electric power line communication system includes: a pair of direct current electric power lines functioning as a pair of communication lines; a plurality of communication devices communicating with each other via the communication lines; and an ignition switch for instructing an operation status of a vehicle. The communication lines coupling between the communication devices are electrically equilibrated. Each communication device applies a high frequency signal to the communication lines so that equilibrium communication is performed. At least one of the communication lines starts and stops supplying direct current electricity according to a status of the ignition switch. Each communication device detects an electric potential of the at least one of the communication lines or a potential difference between the direct current electric power lines. Each communication device determines the operation status of the vehicle based on the electric potential or the potential difference. Each communication device performs the equilibrium communication according to the operation status of the vehicle.

In the above system, each communication device can determine the operation status of the vehicle without adding an external device. Further, each communication device performs the electrically equilibrium communication.

### BRIEF DESCRIPTION OF THE DRAWINGS

The above and other objects, features and advantages of the present invention will become more apparent from the following detailed description made with reference to the accompanying drawings. In the drawings:

FIGS. 1A and 1B are diagrams showing an electric power line communication system mounted in a vehicle according to a first embodiment;

FIG. 2 is a block diagram showing the electric power line communication system applied to a smart entry system;

FIG. 3 is a flowchart showing a control process according to the first embodiment;

FIG. 4 is a diagram showing an electric power line communication system mounted in a vehicle according to a second embodiment;

FIG. 5 is a diagram showing an electric power line communication system mounted in a vehicle according to a third embodiment; and

FIG. 6 is a flowchart showing a control process according to the third embodiment.

### DETAILED DESCRIPTION

### First Embodiment

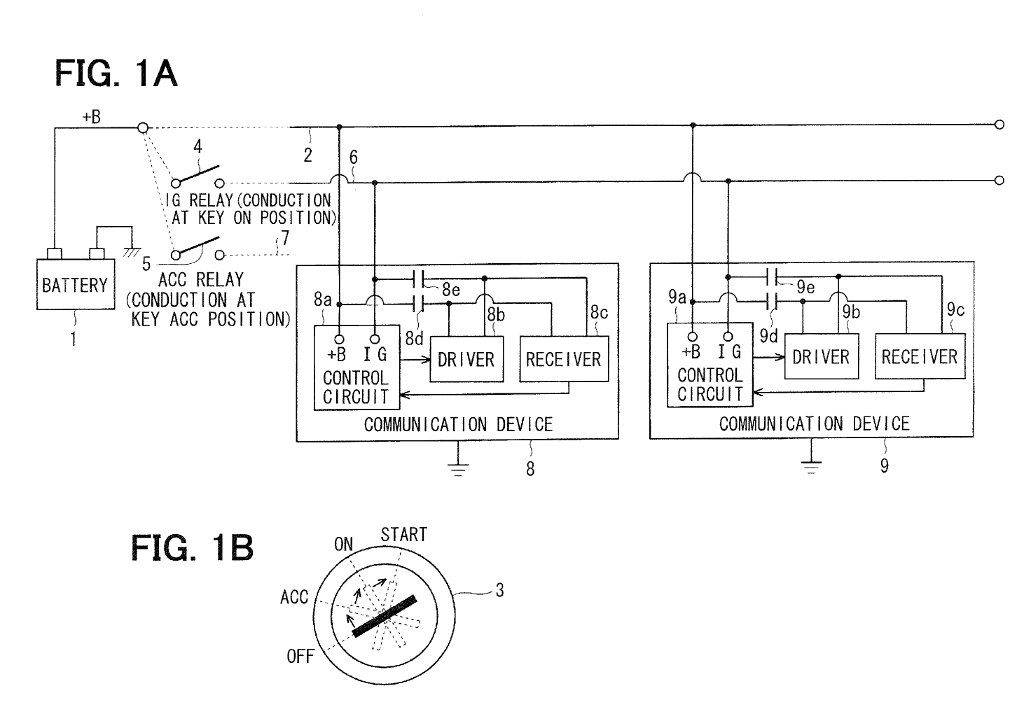

FIG. 1A shows an electric power line communication system mounted on a vehicle. A battery 1 as a power source has a positive terminal for supplying twelve volts is connected to a +B line 2 as an electric power line. Further, the battery 1 is connected to an IG (i.e., ignition) line 6 and an ACC (accessory) line 7 via an IG relay 4 and an ACC relay 5. Here, the IG relay 4 and the ACC relay 5 provide a key switch. The IG relay 4 and the ACC relay 5 turn on and off according to a position of a key cylinder 3, which is shown in FIG. 1B. A negative terminal of the battery 1 is connected to a body of the vehicle as a ground.

Communication devices 8, 9 as an in-vehicle device are connected to the +B line 2 and the IG line 6. Here, although the system includes two devices, the system may include one or more devices such as three communication devices. The +B line 2 and the IG line 6 provide a pair of electric power lines as a pair of communication lines so that electric power line communication is performed. Here, the ground of the communication devices 8, 9 is connected to the body of the vehicle as earth. The device 8 includes a control circuit 8a for controlling communication and other functions, a driver 8b for transmitting a signal, and a receiver 8c for receiving the signal. These circuit 8a, the driver 8b and the receiver 8c are connected to the +B line 2 and the IG line 6. The driver 8b and the receiver 8c are connected to the +B line 2 and the IG line 6 via a capacitor 8d, 8e for cutting a direct current component.

The control circuit 8a includes a micro computer. The control circuit 8a is energized from a power source with a voltage, which is prepared by reducing a voltage of a direct current voltage supplied through the +B line 2. The control circuit 8a reads a voltage level of the IG line 6 with using an A/D converter, which is in the circuit 8a. Thus, the control circuit 8a determines whether the voltage level is 0 volt, or 12 volts. When the voltage level is 0 volt, the IG relay 4 turns off, and when the voltage level is 12 volts, the IG relay 4 turns on, and the key position is at a ON position or a START position. Further, the control circuit 8a inputs transmission data to the driver 8b so that the driver 8b outputs a communication signal to the +B line 2 and the IG line 6 as a communication bus. The receiver 8c receives a signal, and the receiver 8c inputs data, which is decoded by the receiver 8c, into the control circuit 8a. The communication device 9 includes a control circuit 9a, a driver 9b, a receiver 9c, capacitors 9d, 9e, which correspond to each element in the device 8. In this case, the communication devices 8, 9 have a ground of a body of the vehicle, so that communication is performed in an electrically equilibrium condition (i.e., electrically balanced condition) with using the +B line 2 and the IG line 6.

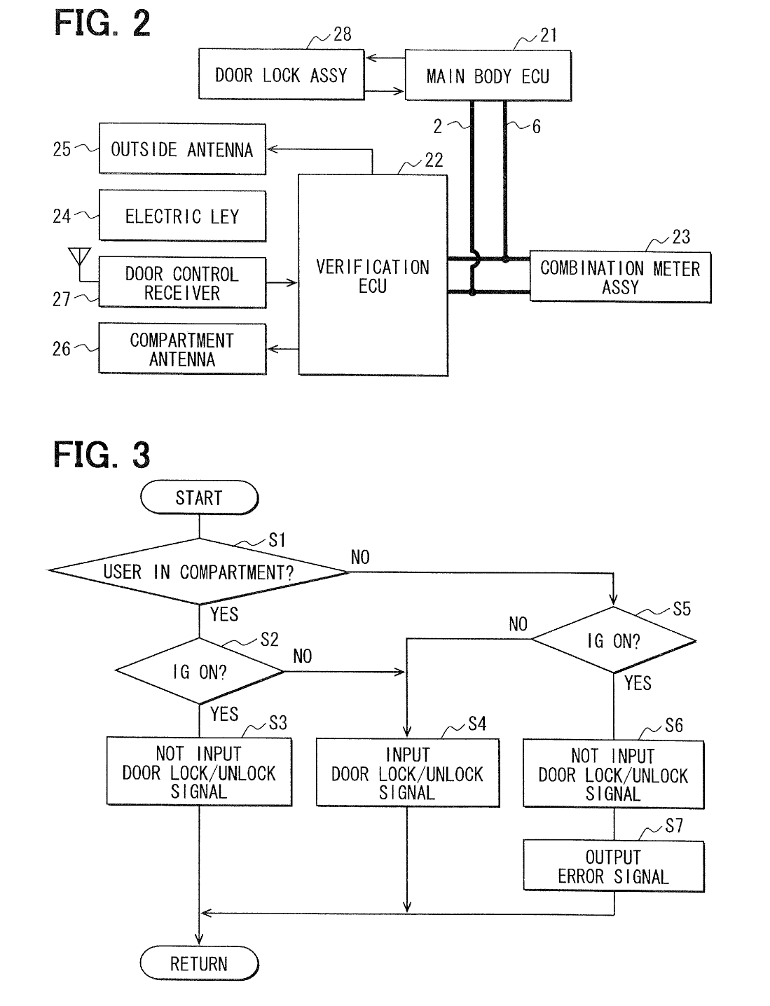

FIG. 2 shows a block diagram in a case where the electric power line communication system is applied to a smart entry system. A main body ECU 21 as a control ECU, a verification ECU 22 as a control ECU and a combination meter assembly 23 as a control ECU correspond to the communication devices 8, 9. Each of the main body ECU 21, the verification ECU 22 and the combination meter assembly 23 is connected to the +B line 2 and the IG line 6. The verification ECU 22 functioning as a driver detecting element sends a request signal via an outside antenna 25 and a compartment antenna 26 intermittently so that the verification ECU 22 determines whether an electric key 24 is located in a detection area of the compartment and a detection area of the outside of the vehicle. Here, the compartment antenna 26 functions as the driver detecting element. Further, the verification ECU 22 verifies an ID (i.e., identification) code when the electric key 24 transmits a ID code signal, the door control receiver 27 receives the ID code signal and decode the signal, and the door control receiver 27 inputs decode data into the verification ECU 22. Here, the electric key 24 includes an operation switch (not shown). When the user switches on the operation switch, the ID code is transmitted to the verification ECU 22.

The door lock assembly 28 is controlled by the main body ECU 21. The door lock assembly 28 drives a door lock actuator to lock and unlock a door of the vehicle. Further, the door lock assembly 28 inputs a status of the door into the main body ECU 21. The combination meter assembly 23 controls a panel of a combination meter to display a warning message or warning lamp according to an instruction from the verification ECU 22. Further, the combination meter assembly 23 inputs a vehicle speed signal into the main body ECU 21. Here, the door lock assembly 28 may provide a door ECU having the same function as the door lock assembly 28 so that the door lock assembly 28 performs the electric power line communication, similar to the main body ECU 21.

Next, functions of the system will be explained with reference to FIG. 3. FIG. 3 shows a flowchart of a control process executed by the verification ECU 22 and the like in the smart entry system. The verification ECU 22 determines according to signals from the compartment antenna 26 and the door control receiver 27 in step S1 whether the electric key 24 is located in a compartment of the vehicle. In general, the driver of the vehicle brings the electric key 24. Thus, the verification ECU 22 determines based on existence of the electric key 24 in the compartment whether the driver as the user is disposed in the compartment.

When the driver is disposed in the compartment, i.e., when the electric key 24 is located in the compartment (when the determination of step S1 is “YES”), it goes to step S2. In step S2, the verification ECU 22 refers to the voltage level of the IG line 6 so that the verification ECU 22 determines whether the position of the key cylinder 3 is located at the “ON” position, i.e., whether the ignition key turns on. Here, when the voltage level of the IG line 6 is zero volt, the position of the key cylinder 3 is a OFF position or a ACC position. In this case, the determination of step S2 is “NO.” Then, it goes to step S4. In step S4, the verification ECU 22 inputs an instruction signal to the door lock assembly 28 via the main body ECU 21 when the ID code is transmitted to the verification ECU 22 according to the operation of the electric key 24 so that the door lock assembly 28 lock or unlock the door of the vehicle in accordance with the status of the door lock at that time.

When the position of the key cylinder 3 is located at the ON position, i.e., when the determination of step S2 is “YES,” the engine of the vehicle has been running. Thus, even when the ID code is transmitted from the electric key 24 to the verification ECU 22, the verification ECU 22 does not accept the ID code. Thus, in step S3, the verification ECU 22 does not input the instruction for locking or unlocking the door of the vehicle into the main body ECU 21.

Further, when the verification ECU 22 determines that the driver is not disposed in the compartment, i.e., when the determination of step S1 is “NO” so that the driver is outside of the vehicle, it goes to step S5. In step S5, the verification ECU 22 determines whether the position of the key cylinder 3 is located at the “ON” position. When the position of the key cylinder 3 is not located at the “ON” position, i.e., when the determination of step S5 is “NO,” it goes to step S4. Then, in step S4, the verification ECU 22 accepts the ID code transmitted from the electric key 24 to the verification ECU 22 according to the operation of the electric key 24.

In step S5, when the verification ECU 22 determines that the position of the key cylinder 3 is located at the “ON” position, i.e., when the determination of step S5 is “YES,” the verification ECU 22 decides that the vehicle is in an abnormal state since the ignition switch turns on although the driver is outside of the vehicle. Then, the verification ECU 22 does not accept the ID code transmitted from the electric key 24 to the verification ECU 22. Thus, in step S6, the verification ECU 22 does not input the instruction for locking or unlocking the door of the vehicle into the main body ECU 21. Further, in step S7, the verification ECU 22 transmits an instruction to the combination meter assembly 23 so that the combination meter assembly 23 outputs error signal. For example, the panel of the combination meter assembly 23 displays the warning notice that represents the electric key 24 is not in the compartment.

In the present embodiment, at least one of the communication lines, i.e., at least one of the +B line 2 and the IG line 6, provides a direct current power supply line for supplying direct current electricity intermittently in accordance with the status of the key switch, which turns on and off in association with the position of the key cylinder 3. Specifically, both of the +B line 2 and the IG line 6 provide the communication lines. When the key position is located at the ON position, the direct current electricity is supplied so that the electric potential of the IG line 6 increases. The communication devices 8, 9 determine the operation status of the vehicle based on the electric potential change of the IG line 6. Then, the devices 8, 9 perform the communication in accordance with the determination result of the operation status of the vehicle. Accordingly, the communication devices 8, 9 can determine the status of the key switch, i.e., the IG relay 4, which corresponds to the operation status of the vehicle, without adding an external element.

Further, the electric power line communication system is applied to the smart entry system, i.e., applied to the main body ECU 21, the verification ECU 22 and the combination meter assembly 23. The verification ECU 22 determines according to the existence of the driver in the compartment of the vehicle and the status of the key cylinder 3 (i.e., the key cylinder 3 is located at the OFF position) whether the door lock/unlock control for the door of the vehicle is performed based on the ID code transmitted from the electric key 24. Accordingly, the verification ECU 22 controls appropriately the door lock assembly 28 and the like according to the status of the IG relay 4.

### Second Embodiment

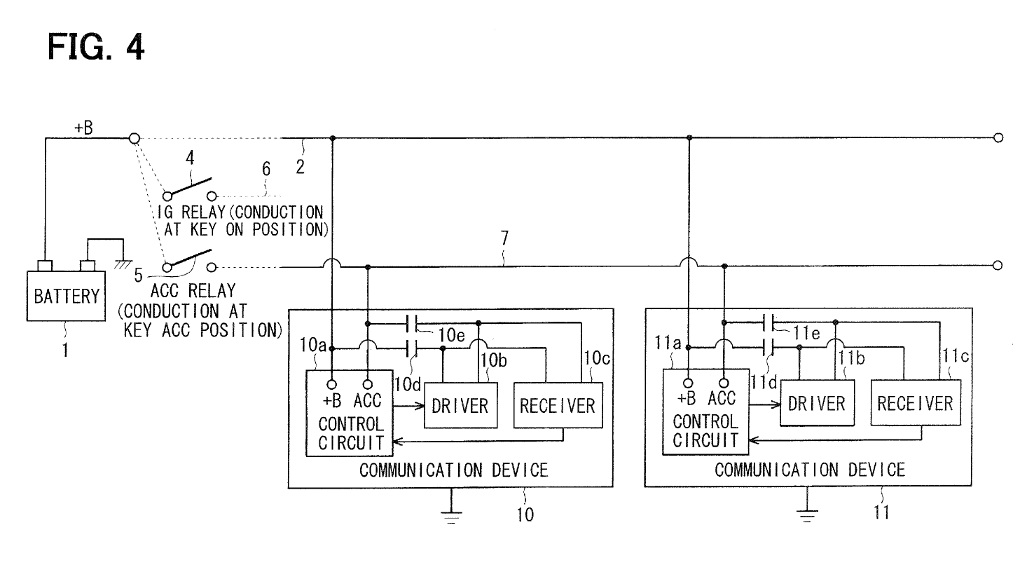

FIG. 4 shows an electric power line communication system mounted on a vehicle according to a second embodiment. FIG. 4 corresponds to FIG. 1A. The communication devices 10, 11 instead of the devices 8, 9 communicate with each other via the +B line 2 and the ACC line 7. Thus, one of the communication lines is not the IG line 6 but the ACC line 7. Specifically, the electric potential of the ACC line 7 is twelve volts when the position of the key cylinder 3 is located at one of the ACC position, the ON position and the START position. Thus, each control circuit 10a, 11a of the communication devices 10, 11 determines that the position of the key cylinder 3 is located at one of the ACC position, the ON position and the START position when the electric potential of the ACC line 7 is 12 volts. The control circuit 10a, 11a of the communication devices 10, 11 determines that the position of the key cylinder 3 is located at the OFF position when the electric potential of the ACC line 7 is 0 volt. Accordingly, the effects and the functions according to the second embodiment are similar to the first embodiment.

### Third Embodiment

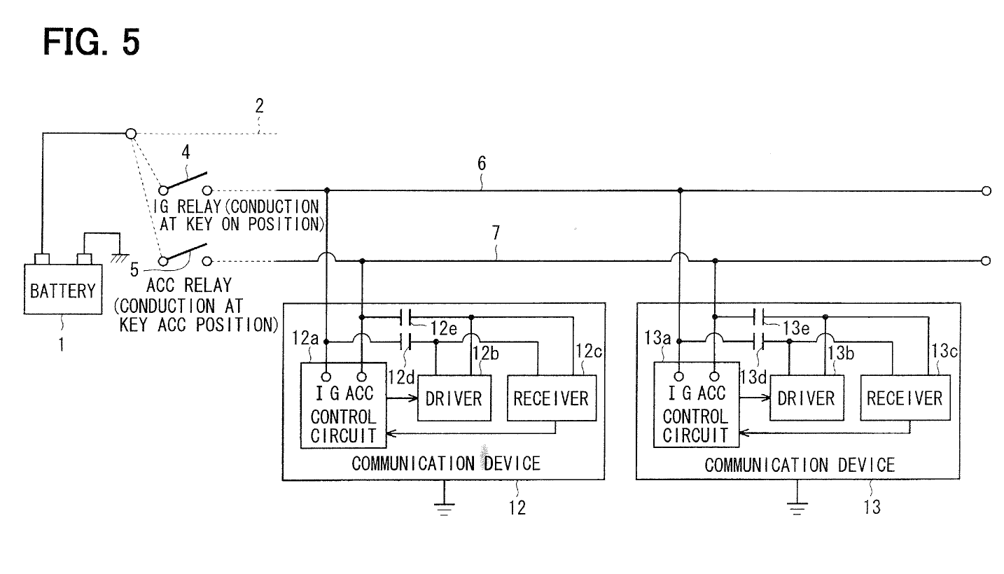

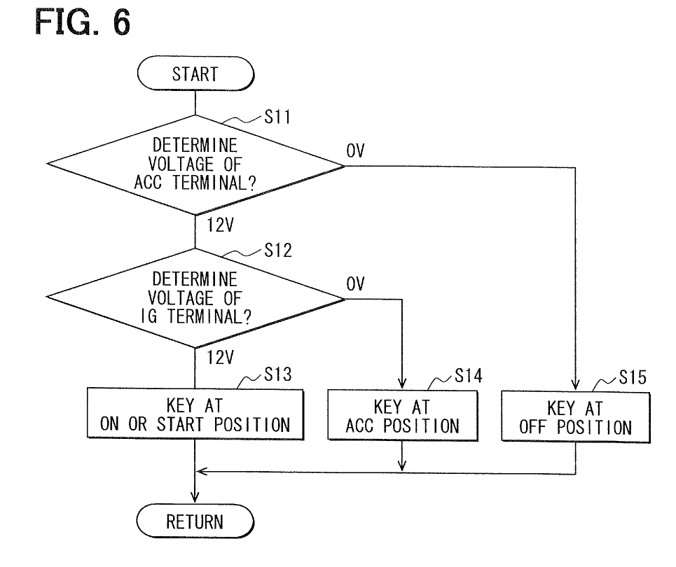

FIGS. 5 and 6 show an electric power line communication system mounted on a vehicle according to a third embodiment. FIG. 5 corresponds to FIG. 4. The communication devices 12, 13 instead of the devices 10, 11 communicate with each other via the IG line 6 and the ACC line 7. Thus, one of the communication lines is not the +B line 2 but the IG line 6. Accordingly, when one of the IGF relay 4 and the ACC relay 5 turns on, the communication devices 12, 13 are energized so that the devices 12, 13 starts to function.

FIG. 6 shows a flowchart of a process executed by the control circuit 12a of the communication device 12. When one of the IG relay 4 and the ACC relay 5 turns on, the device 12 starts to execute the process in FIG. 6. In steps S11 and S12, the control circuit 12a determines whether the voltage of the ACC line 7 and the voltage of the IG line 6 are 12 volts or 0 volt, respectively. When both of the voltages of the ACC line 7 and the IG line 6 are twelve volts, i.e., when the determination of step S11 and the determination of step S12 are “12V,” it goes to step S13. In step S13, the control circuit 12a determines that the position of the key cylinder 3 is the ON position or the START position. When the voltage of the ACC line 7 is twelve volts, and the voltage of the IG line 6 is zero volt, i.e., when the determination of step S11 is “12V” and the determination of step S12 is “0V,” it goes to step S14. In step S14, the control circuit 12a determines that the position of the key cylinder 3 is the ACC position.

When the communication devices 12, 13 includes a back-up power supply or a charging element such as a capacitor or a secondary battery so that the devices 12, 13 functions even if both of the voltages of the ACC line 7 and the IG line 6 are zero volt, the devices 12, 13 can determines that the position of the key cylinder 3 is the OFF position. In this case, when the voltage of ACC line 7 is zero volt, i.e., when the determination of step S11 is “0V,” it goes to step S15. In step S15, the control circuit 12a determines that the position of the key cylinder 3 is the OFF position.

Thus, in the third embodiment, the communication devices 12, 13 perform the electric power line communication with using the IG line 6 and the ACC line 7 as the communication lines. Thus, when the devices 12, 13 function in a case where the position of the key cylinder 3 is one of the ACC position, the On position and the START position, the effects similar to the first and second embodiments are obtained. When the communication devices 12, 13 include the back-up power supply, the effects similar to the first and second embodiments are obtained while the devices 12, 13 can be operated by the back-up power supply.

### Modifications

In the first embodiment, the voltage of the IG line 6 is detected. Alternatively, the potential difference between the +B line 2 and the IG line 6 may be detected.

Further, a comparator and/or a differential amplifier for detecting the voltage change may be used, and the control circuit determines based on the signal level of the output signal from the comparator and/or the differential amplifier.

The driver detecting element may be a sensor for detecting a person such as an infra-red sensor or a pressure sensor arranged on a seat of the vehicle.

The electric power line communication system according to the second and third embodiments may be applied to the smart entry system.

Alternatively, the electric power line communication system according to the first to third embodiments may be applied to any in-vehicle system.

The above disclosure has the following aspects.

According to an aspect of the present disclosure, an in-vehicle electric power line communication system includes: a pair of direct current electric power lines functioning as a pair of communication lines; a plurality of communication devices communicating with each other via the communication lines; and an ignition switch for instructing an operation status of a vehicle. The communication lines coupling between the communication devices are electrically equilibrated. Each communication device applies a high frequency signal to the communication lines so that equilibrium communication is performed. At least one of the communication lines starts and stops supplying direct current electricity according to a status of the ignition switch. Each communication device detects an electric potential of the at least one of the communication lines or a potential difference between the direct current electric power lines. Each communication device determines the operation status of the vehicle based on the electric potential or the potential difference. Each communication device performs the equilibrium communication according to the operation status of the vehicle.

In the above system, each communication device can determine the operation status of the vehicle without adding an external device. Further, each communication device performs the electrically equilibrium communication.

Alternatively, the pair of direct current electric power lines may be a battery line and an ignition line of the vehicle. Specifically, when the operation status of the vehicle is the ignition on status after the driver starts the engine of the vehicle, the direct current electricity is supplied so that the potential of the ignition line increases. Thus, by detecting the potential change of the ignition line, the operation status of the vehicle is determined.

Alternatively, the pair of direct current electric power lines may be a battery line and an accessory line of the vehicle. Specifically, the direct current electricity is supplied, and the potential of accessory line increases when the operation status of the vehicle is the accessory status, and when the operation status of the vehicle is the ignition on status after the driver starts the engine of the vehicle. Thus, by detecting the potential change of the accessory line, the operation status of the vehicle is determined.

Alternatively, the pair of direct current electric power lines may be an accessory line and an ignition line of the vehicle. In this case, the device starts to function when the operation status of the vehicle is the accessory status. By detecting the potential change of the ignition line or the accessory line, the operation status of the vehicle is determined. Further, when the device includes a back-up power supply, which is energized during the electricity is supplied to the device via the ignition line or the accessory line, By detecting the potential change of the ignition line or the accessory line, the operation status of the vehicle is determined.

Alternatively, the communication devices may include a plurality of electronic control units in a smart entry system of the vehicle. The electronic control units includes a first electronic control unit, a second electronic control unit and a third electronic control unit. The first electronic control unit includes a driver detector for detecting a driver in a compartment of the vehicle. The first electronic control unit transmits a control instruction signal to the second electronic control unit so that the second electronic control unit locks and unlocks a door of the vehicle based on a lock and unlock signal from a smart key when the operation status of the vehicle is an ignition off status. The first electronic control unit does not transmit the control instruction signal to the second electronic control unit when the driver detector detects the driver in the compartment of the vehicle, and the operation status of the vehicle is an ignition on status. The first electronic control unit does not transmit the control instruction signal to the second electronic control unit, and the first electronic control unit transmits another control instruction signal to the third electronic control unit so that the third electronic control unit outputs an error signal when the driver detector does not detect the driver in the compartment of the vehicle, and the operation status of the vehicle is the ignition on status. In this case, the first electronic control unit controls appropriately according to the status of the ignition switch.

Alternatively, the operation status of the vehicle may include an ignition off status, an ignition on status, an accessory position status, and an engine start status.

Further, the pair of direct current electric power lines may be a battery line and an ignition line of the vehicle. One end of the battery line is coupled with a battery of the vehicle. Each communication device includes a control circuit, a driver circuit and a receiver. The control circuit is coupled with the battery line and the ignition line so that the control circuit is energized by the battery via the battery line. The driver circuit and the receiver are coupled with the battery line and the ignition line via a capacitor, respectively. The driver circuit outputs the high frequency signal to the battery line and the ignition line. The receiver receives the high frequency signal via the battery line and the ignition line.

Alternatively, each communication device may have a ground of a body of the vehicle so that the equilibrium communication is performed with using the battery line and the ignition line.

Alternatively, the communication devices may include a plurality of electronic control units in a smart entry system of the vehicle. The electronic control units includes a main body electronic control unit, a verification electronic control unit and a combination meter electronic control unit. The verification electronic control unit includes a driver detector for detecting a driver in a compartment of the vehicle. The verification electronic control unit transmits a control instruction signal to the main body electronic control unit so that the main body electronic control unit locks and unlocks a door of the vehicle based on a lock and unlock signal from a smart key when the operation status of the vehicle is an ignition off status. The verification electronic control unit does not transmit the control instruction signal to the main body electronic control unit when the driver detector detects the driver in the compartment of the vehicle, and the operation status of the vehicle is an ignition on status. The verification electronic control unit does not transmit the control instruction signal to the main body electronic control unit, and the verification electronic control unit transmits another control instruction signal to the combination meter electronic control unit so that the combination meter electronic control unit outputs a warning signal when the driver detector does not detect the driver in the compartment of the vehicle, and the operation status of the vehicle is the ignition on status.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An in-vehicle electric power line communication system comprising:
a pair of direct current electric power lines functioning as a pair of communication lines;
a plurality of communication devices communicating with each other via the communication lines; and
an ignition switch for instructing an operation status of a vehicle,
wherein the communication lines coupling between the communication devices are electrically equilibrated,
wherein each communication device applies a high frequency signal to the communication lines so that equilibrium communication is performed,
wherein at least one of the communication lines starts and stops supplying direct current electricity according to a status of the ignition switch,
wherein each communication device detects an electric potential of the at least one of the communication lines or a potential difference between the direct current electric power lines,
wherein each communication device determines the operation status of the vehicle based on the electric potential or the potential difference, and
wherein each communication device performs the equilibrium communication according to the operation status of the vehicle.

2. The in-vehicle electric power line communication system according to claim 1,
wherein the pair of direct current electric power lines are a battery line and an ignition line of the vehicle.

3. The in-vehicle electric power line communication system according to claim 1,
wherein the pair of direct current electric power lines are a battery line and an accessory line of the vehicle.

4. The in-vehicle electric power line communication system according to claim 1,
wherein the pair of direct current electric power lines are an accessory line and an ignition line of the vehicle.

5. The in-vehicle electric power line communication system according to claim 1,
wherein the communication devices include a plurality of electronic control units in a smart entry system of the vehicle,
wherein the electronic control units includes a first electronic control unit, a second electronic control unit and a third electronic control unit,
wherein the first electronic control unit includes a driver detector for detecting a driver in a compartment of the vehicle,
wherein the first electronic control unit transmits a control instruction signal to the second electronic control unit so that the second electronic control unit locks and unlocks a door of the vehicle based on a lock and unlock signal from a smart key when the operation status of the vehicle is an ignition off status,
wherein the first electronic control unit does not transmit the control instruction signal to the second electronic control unit when the driver detector detects the driver in the compartment of the vehicle, and the operation status of the vehicle is an ignition on status, and
wherein the first electronic control unit does not transmit the control instruction signal to the second electronic control unit, and the first electronic control unit transmits another control instruction signal to the third electronic control unit so that the third electronic control unit outputs an error signal when the driver detector does not detect the driver in the compartment of the vehicle, and the operation status of the vehicle is the ignition on status.

6. The in-vehicle electric power line communication system according to claim 1,
wherein the operation status of the vehicle includes an ignition off status, an ignition on status, an accessory position status, and an engine start status.

7. The in-vehicle electric power line communication system according to claim 6,
wherein the pair of direct current electric power lines are a battery line and an ignition line of the vehicle,
wherein one end of the battery line is coupled with a battery of the vehicle,
wherein each communication device includes a control circuit, a driver circuit and a receiver,
wherein the control circuit is coupled with the battery line and the ignition line so that the control circuit is energized by the battery via the battery line,
wherein the driver circuit and the receiver are coupled with the battery line and the ignition line via a capacitor, respectively,
wherein the driver circuit outputs the high frequency signal to the battery line and the ignition line, and
wherein the receiver receives the high frequency signal via the battery line and the ignition line.

8. The in-vehicle electric power line communication system according to claim 7,
wherein each communication device has a ground of a body of the vehicle so that the equilibrium communication is performed with using the battery line and the ignition line.

9. The in-vehicle electric power line communication system according to claim 8,
wherein the communication devices include a plurality of electronic control units in a smart entry system of the vehicle,
wherein the electronic control units includes a main body electronic control unit, a verification electronic control unit and a combination meter electronic control unit,
wherein the verification electronic control unit includes a driver detector for detecting a driver in a compartment of the vehicle,
wherein the verification electronic control unit transmits a control instruction signal to the main body electronic control unit so that the main body electronic control unit locks and unlocks a door of the vehicle based on a lock and unlock signal from a smart key when the operation status of the vehicle is an ignition off status,
wherein the verification electronic control unit does not transmit the control instruction signal to the main body electronic control unit when the driver detector detects the driver in the compartment of the vehicle, and the operation status of the vehicle is an ignition on status, and
wherein the verification electronic control unit does not transmit the control instruction signal to the main body electronic control unit, and the verification electronic control unit transmits another control instruction signal to the combination meter electronic control unit so that the combination meter electronic control unit outputs a warning signal when the driver detector does not detect the driver in the compartment of the vehicle, and the operation status of the vehicle is the ignition on status.
